(19) United States
(12) Patent Application Publication
(10) Pub. No.: US 2025/0093910 A1
(43) Pub. Date: Mar. 20, 2025

(54) Head-Mounted Devices With Head Straps

(71) Applicant: Apple Inc., Cupertino, CA (US)

(72) Inventors: John A. Porcella, Campbell, CA (US); Zachary M. Hammond, Mountain View, CA (US); Dustin A. Hatfield, Campbell, CA (US); Megan Grant, San Francisco, CA (US)

(21) Appl. No.: 18/470,297

(22) Filed: Sep. 19, 2023

(51) Int. Cl. G06F 1/16

(52) U.S. Cl. CPC G06F 1/163

(57) ABSTRACT

A head-mounted device may include optical assemblies for presenting images to a user. The optical assemblies may be mounted in a head-mounted device housing. The head-mounted device housing may be supported at the front of the head of a user in front of the user's eyes using head-mounted support structures such as straps. The straps may include upper and lower straps. The upper and lower straps may be coupled to a rigid extending portion of the head-mounted device in a configuration that applies torque to the rigid extending portion and thereby helps to lift the head-mounted device housing upwardly. Releasable and/or rotatable connections may be used in coupling the straps to the rigid extending portion.

### FIELD

This relates generally to electronic devices, and, more particularly, to electronic devices such as head-mounted devices.

### BACKGROUND

Electronic devices such as head-mounted devise may have components such as displays and lenses. Straps may be used to help hold head-mounted devices on the heads of users.

### SUMMARY

A head-mounted device may include displays and lenses for displaying images for a user when the head-mounted device is worn on the head of the user. The head-mounted device may have a housing that is configured to rest at the front of the user's head. Head straps such as upper and lower head straps may be provided at the rear of the user's head.

The upper and lower straps may be coupled to a rigid extending portion of the head-mounted device in a configuration that applies torque to the rigid extending portion and thereby helps to lift the head-mounted device housing upwardly. Releasable and/or rotatable connections may be used in coupling the straps to the rigid extending portion.

In an illustrative arrangement, the head-mounted device may be coupled to a pivoting rigid bar that extends from the head-mounted housing to the rear of the user's head. A tensioner that is coupled between the rigid bar and the lower strap may be used to rotate the rigid bar to help lift the head-mounted housing upwardly.

### BRIEF DESCRIPTION OF THE DRAWINGS

FIG. 1 is a side view of an illustrative head-mounted device on a head of a user in accordance with an embodiment.

FIGS. 2, 3, and 4 are side views of portions of illustrative head-mounted device strap systems in accordance with embodiments.

FIGS. 5 and 6 are side views of illustrative head-mounted devices in accordance with embodiments.

### DETAILED DESCRIPTION

Head-mounted devices may have housings that are supported on a user's head using support structures such as straps. A head-mounted device may have a housing that rests against the front of a user's head in alignment with the user's eyes during use. This allows displays in the housing to display images for the user. The weight of the displays and other components in the housing tends to pull downwardly on the front of a user's head. To counterbalance this force, a head-mounted device may be provided with straps are configured to create a lifting force on the housing. This uplifting force can help relieve some of the weight of the housing, thereby enhancing user comfort.

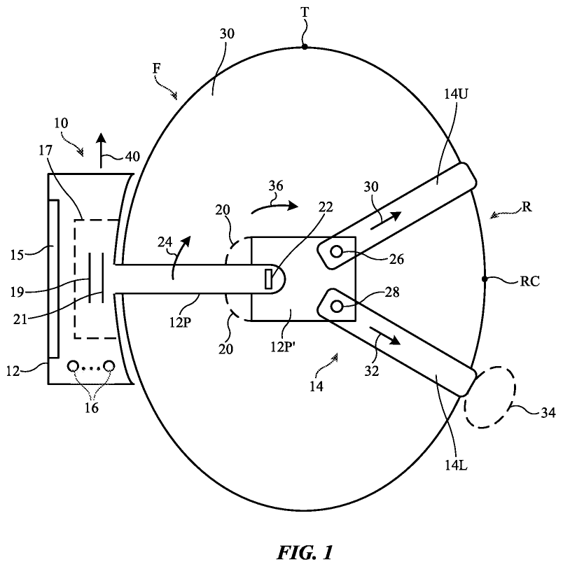

FIG. 1 is a side view of an illustrative head-mounted device of the type that may be provided with a strap system that generates a lifting force for its housing. As shown in FIG. 1, head-mounted device 10 may have a head-mounted housing such as head-mounted housing 12. Housing 12 may be worn on front F of a user's head (head 30). Straps 14 may be used to help support housing 12 on head 30. In the example of FIG. 1, the strap system for device 10 has straps 14U and 14L. Strap 14U may be an upper strap (sometimes referred to as an upper-rear-head strap) that generally rests on the user's head at a location partway between the top of the user's head (top T of head 30 of FIG. 1) and the rearmost portion of the head (see, e.g., rear center RC of head 30 of FIG. 1, which lies in the middle of the rear of the user's head). Strap 14L may be a lower strap (sometimes referred to as a lower-rear head strap) that generally rests on rear R of the user's head below rear center RC.

Housing 12 may contain a forward-facing display such as display 15 (e.g., a three-dimensional display having lenticular lenses overlapping an array of display pixels and other components 16 (e.g., control circuitry such as microprocessor circuitry, storage, application-specific integrated circuits, sensors, speakers, an optional battery, etc.). Left and right optical assemblies 17 (sometimes referred to as optical modules) may be used to display images in eye boxes. When a user's eyes are located in the eye boxes, left and right displays 19 and corresponding left and right lenses 21 in optical assemblies 17 may present images to the user. Head-mounted housing 12 may have rigid portions (e.g., a polymer shell, a glass cover layer over display 15, metal frame structures, and rigid structures formed from combinations of polymer, ceramic, glass, metal, and/or other rigid materials). These rigid structures may include elongated rigid housing extensions such as extension 12P (sometimes referred to as a power strap, elongated rigid housing portion, or rigid strap portion). Extension 12P may extend rearwardly from housing 12 and may be an integral part of housing 12 or may be rigidly attached to housing 12.

Straps 14U and 14L may be attached to a strap anchoring structure such as support member 12P′ (sometimes referred to as a strap anchor or strap support). Member 12P′ may be formed as an integral portion of extension 12P as depicted by dashed lines 20 or may be separate from extension 12P. In arrangements in which member 12P′ is separate from extension 14P, member 12P′ may be removably attached to extension 12P using releasable (detachable) connection 22. Releasable connections 22 may each have a rectangular protrusion that mates with a corresponding rectangular recess. A releasable latching mechanism (e.g., a spring-based catch) may be included in connection 22, so that a user may press on or slide a button, may pull on a tab, or may otherwise release connection 22 when it is desired to separate member 12P′ from extension 12P. The protrusion of connection 22 may be located on extension 12P and the recess may be located on member 12P′ or the protrusion may be located on member 12P′ and the recess may be located on extension 12P (as examples). The rectangular shape of connection 22 helps form a solid and rigid connection between member 12P′ and extension 12P, so that torque can be transferred from member 12P′ to extension 12P. Connections 22 may also be used on straps and other structures in device 10, if desired.

To help counteract some of the weight of housing 12, straps 14 (and member 12P′, which may optionally be formed as part of straps 14), may be configured to provide torque to extension 12P in direction 24. This may be accomplished by satisfactory configuration of the connections between straps 14 and member 12P′ and satisfactory configuration of the locations at which straps 14 are worn on the user's head. In the example of FIG. 1, straps 14U and 14L are attached to member 12P′ at respective attachment points 26 and 28 using fixed and/or releasable connection mechanisms. With this arrangement, upper strap 14U exerts a force on point 26 on member 12P′ in direction 30 and lower strap 14L exerts a force on point 28 on member 12P′ in direction 32. An optional weight such as mass 34 (e.g., a metal mass of 20-800 grams) may serve as ballast for strap 14L and may help increase the magnitude of the force exerted by strap 14L.

Attachment points 26 and 28 are offset from each other. Due to the interactions between the force exerted in direction 30 and the force exerted in direction 32 and the locations of attachments points 26 and 28, member 12P′ is caused to rotate in direction 36 (e.g., the straps cause clockwise rotation and torque in the example of FIG. 1). Due to the rigid connection between member 12P′ and extension 12P, the clockwise torque of member 12P′ cause clockwise torque on extension 12P and causes extension 12P to rotate in direction 36 with member 12P′. In this way, clockwise torque is created by the action of straps 14U and 14L on member 12P and is transferred to housing 12, where this torque tends to lift housing 12 in upwards direction 40. This effectively counteracts some of the weight of housing 12 and therefore reduces the downward force of housing 12 on the user's face, increasing comfort.

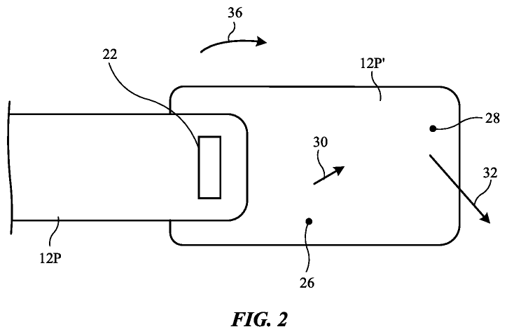

In the example of FIG. 1, straps 14 on the lefthand side of head 30 are configured so that attachment point 26 for strap 14U is located above and slightly to the left of attachment point 30. These attachment points may be placed at other locations on member 12P′. As an example, attachment point 26 may be located below and to the left of attachment point 28, as shown in FIG. 2. In general, any suitable locations may be used for points 26 and 28, provided that torque is generated for extensions 12P on the left and right sides of the user's head to lift housing 12 in direction 40 and thereby bear some of the weight of housing 12.

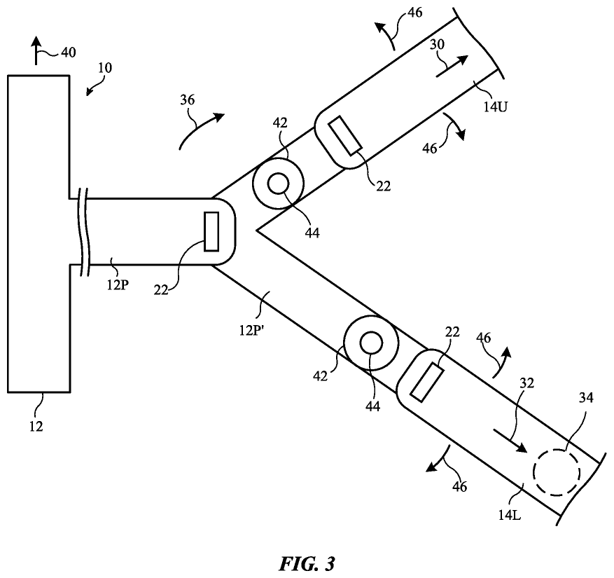

If desired, member 12P′ may be configured to allow angular adjustment to the orientations of straps 14U and 14L. This type of arrangement is shown in FIG. 3. In the example of FIG. 3, member 12P′ has an upper portion (e.g., an upper leg) that is coupled to strap 14U using a releasable connection 22 and has a lower portion (e.g., a lower leg) that is coupled to strap 14L via a releasable connection 22. Optional lockable rotating joints 42 may be interposed within the upper and lower legs to allow the angular orientation of straps 14U and 14L to be adjusted, as shown by arrows 46. Rotating joints 42 (sometimes referred to as rotating connectors) may have optional rotational detents (e.g., detents separated by 2-5° from each other or detents with different angular spacings) and may optionally be further secured using optional fasteners 44 (e.g., thumb-tightened screws or other latches that help lock the angular orientation of the rotating joints). Rotating joints 42 may, as an example, be unlocked (rotationally released) to allow straps 14U and 14L to be placed in desired locations on the user's head and then subsequently locked by tightening fasteners 44 to prevent undesired rotation after a selected angular orientation for each strap has been obtained. If desired, one or both of rotating joints 42 may be omitted from member 12P′. In the example of FIG. 3, straps 14U and 14L have been attached to member 12P′ using releasable connections 22. If desired, straps 14U and 14L may be attached to member 12P′ using fixed (non-releasable) connections, snaps, connections formed by looping strips of strap material (e.g., fabric strips) through respective slots in member 12P′, or other attachment mechanisms. If desired, each strap may be permanently connected to member 12P′ using a rotating joint (e.g., a pivoting connection without a release mechanism and optionally without a locking mechanism).

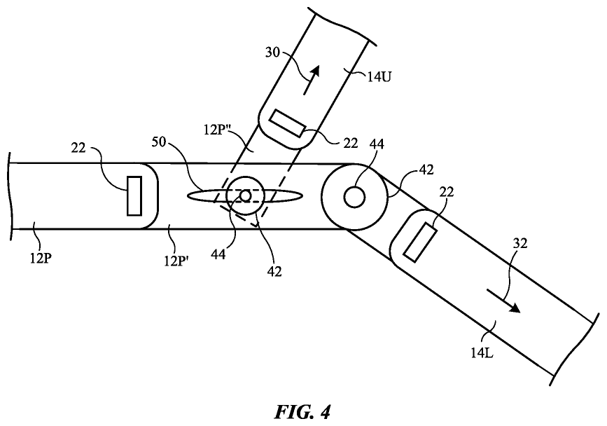

In the illustrative configuration of FIG. 4, strap 14U is attached to member 12P′ using member 12P″ and a rotating joint 42 that is mounted in a slot 50. When it is desired to adjust the position of this rotating joint 42 within slot 50, its fastener 44 can be loosened and this rotating joint 42 for strap 14U may be slid along slot 50 by the user to a new location. After adjusting the lateral position (and, if desired, angular orientation) for strap 14U in this way, its fastener 44 can be tightened. The angular orientation of strap 14L may also be adjusted using its rotating joint. Member 14P′ of FIG. 4 may be attached to extension 14P using a releasable connection 22 and straps 14U and 14L may be connected to members 14P″ and 14P′ using releasable connections 22. When device 10 is being worn on head 30, the forces applied to member 12P′ in directions 30 and 32 cause member 12P′ and therefore extension 12P to rotate in direction 36, thereby lifting housing 12.

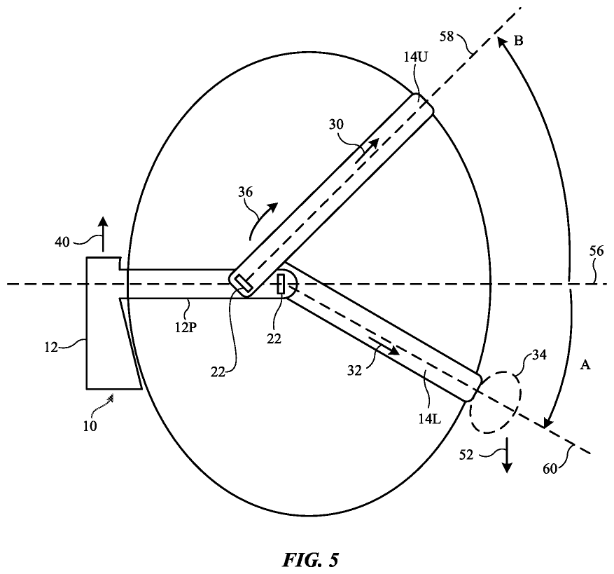

Another illustrative arrangement for straps 14 that may help apply upward force to housing 12 is shown in FIG. 5. In this arrangement, strap 14L is attached directly to extension 12P using a releasable connection 22 and strap 14U is attached directly to extension 12P using a releasable connection 22. Arrangements in which strap 14U is attached directly to strap 12L instead of extension 12P, in which strap 14U is fixedly attached to strap 14L, in which strap 14U is formed as an integral part of strap 14L, and in which an adjustable rotating connection of the type shown by connection 42 of FIG. 4 is used to attach strap 14U to strap 14L may also be used.

Optional mass (weight) 34 may be added to strap 14L to serve as ballast. Weight 34 pulls downwards in direction 52 on the end of strap 14L and may help increase the torque that is applied to extension 12P in direction 36. As shown in FIG. 5, extension 12P may extend along horizontal axis 56, strap 14U may extend along axis 58, which is oriented at an angle B above axis 56, and strap 14L may extend along axis 60, which is oriented at an angel A below axis 56. The values of A and B may be, for example, 10-85°. 15-80°, 30-80°, or other suitable angular orientation values. These angular orientations for the straps of device 10 may also be used in arrangements of the type shown in FIGS. 1, 2, 3, and 4.

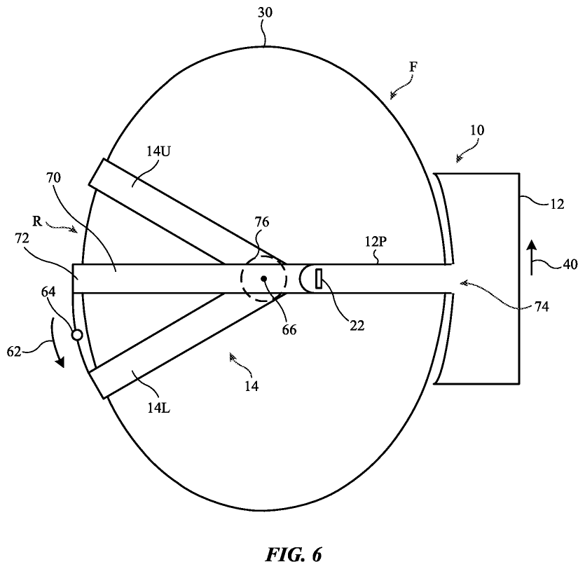

In the example of FIG. 6, straps 14U and 14L are used to grip rear R of the user's head 30 and may, as with straps 14U and 14L in FIGS. 1, 2, 3, 4, and 5, be formed from comfortable flexible materials such as fabric. Rigid extending member 70 may be formed from a rigid material such as rigid polymer, metal, or other rigid material(s). Extending member 70 may be connected to extension 12P using releasable connection 22 or may be formed as part of extension 12P. These arrangements form a horizontally extending rigid bar with first and second opposing ends at front F and rear R of head 30, respectively. A rotatable connection such as connection 66 (sometimes referred to as a pivot) may be used to rotatably connect member 72 (and therefore the rigid bar) to a support structure such as member 76 that is attached to straps 14U and 14L.

The rigid bar rigidly connects portion 72 of member 70 at rear R of head 30 to portion 74 of housing 12 at front F of head 30. Adjustable tensioner 64 may be coupled between portion 72 of member 70 and the rear portion of strap 14L. Tensioner 64 may be formed from an adjustable-length cord (as an example) or a spring or other tensioning structure that can pull portion 72 downward in direction 62. The downward force in direction 62 on portion 72 of member 70 causes extension 12P and member 72 to rotate about connection 66 in direction 78 (counterclockwise in FIG. 6), thereby lifting portion 74 and housing 12 upward in direction 40. By adjusting tensioner 64, the amount of upward lift that is provided to housing 12 to reduce the effective weight of housing 12 at front F of head 30 may be adjusted.

The foregoing is merely illustrative and various modifications can be made to the described embodiments. The foregoing embodiments may be implemented individually or in any combination.

What is claimed is:

1. A head-mounted device, comprising:
a head-mounted housing having a rigid portion;
displays in the head-mounted housing that are configured to display images; and
straps coupled to the rigid portion that are configured to apply torque to the rigid portion when the head-mounted housing is being worn that helps lift the head-mounted housing upwardly.

2. The head-mounted device defined in claim 1 wherein the straps include an upper strap and a lower strap.

3. The head-mounted device defined in claim 2 further comprising a rigid strap anchor that is rigidly coupled to the rigid portion and wherein the upper strap and lower strap are connected to the strap anchor.

4. The head-mounted device defined in claim 3 wherein the rigid portion comprises a rigid extension that extends rearwardly from the head-mounted housing.

5. The head-mounted device defined in claim 4 wherein the strap anchor is coupled to the rigid extension with a releasable connection.

6. The head-mounted device defined in claim 5 wherein the upper strap is coupled to the strap anchor with a first additional releasable connection and wherein the lower strap is coupled to the strap anchor with a second additional releasable connection.

7. The head-mounted device defined in claim 6 wherein the further comprising:
a first rotatable connection interposed between the releasable connection and the first additional releasable connection; and
a second rotatable connection interposed between the releasable connection and the second additional releasable connection.

8. The head-mounted device defined in claim 7 wherein the first and second rotatable connections are configured to rotationally release to permit adjustments to angular orientations for the first and second straps, respectively, and are configured to lock in place following angular orientation adjustments.

9. The head-mounted device defined in claim 2 wherein the rigid portion comprises a rigid extension that extends rearwardly from the head-mounted housing and wherein the lower strap is releasably connected to the rigid extension.

10. The head-mounted device defined in claim 9 wherein the upper strap is releasably connected directly to the lower strap.

11. The head-mounted device defined in claim 6 wherein the upper strap extends along a first axis that is oriented at an angle of 15-80° with respect to a horizontal axis and wherein the lower strap extends along a second axis that is oriented at an angle of 15-80° with respect to the horizontal axis.

12. The head-mounted device defined in claim 11 further comprising a metal mass coupled to the lower strap that enhances lifting of the head-mounted device.

13. A head-mounted device, comprising:
a head-mounted housing having a rigid extension;
displays and lenses in the head-mounted housing; and
upper and lower straps coupled to the rigid extension that are configured to apply torque to the rigid extension when the head-mounted housing is being worn that helps lift the head-mounted housing upwardly.

14. The head-mounted device defined in claim 13 further comprising a rigid member that is releasably coupled to the rigid extension, wherein the upper and lower straps are coupled to the rigid member and are configured to apply torque to the rigid member and wherein the rigid member transfers the applied torque to the rigid extension.

15. The head-mounted device defined in claim 14 wherein the upper strap extends along a first axis that is oriented at an angle of 15-80° with respect to a horizontal axis that extends along the rigid extension and wherein the lower strap extends along a second axis that is oriented at an angle of 15-80° with respect to the horizontal axis.

16. The head-mounted device defined in claim 15 wherein:
the upper strap is rotatably coupled to the rigid member using a first rotatable connector; and
the lower strap is rotatably coupled to the rigid member using a second rotatable connector.

17. The head-mounted device defined in claim 16 wherein the rigid member has a slot and wherein the first rotatable connector is configured to slide along the slot.

18. A head-mounted device, comprising:
a head-mounted housing;
displays and lenses in the head-mounted housing;
a rigid bar having first and second ends, wherein the first end is coupled to the head-mounted housing;
head straps, wherein the rigid bar is rotatably coupled to the head straps and
a tensioner configured to pull downwardly on the second end of the rigid bar to rotate the rigid bar and help lift the head-mounted housing upwardly.

19. The head-mounted device defined in claim 18 wherein the head straps include an upper head strap and a lower head strap and wherein the tensioner is coupled between the second end of the rigid bar and the lower strap.

20. The head-mounted device defined in claim 19 wherein the head-mounted housing has a rigid extension and wherein the rigid bar is formed from an elongated member that is releasably coupled to the rigid extension.
